(19) United States
(12) Patent Application Publication
(10) Pub. No.: US 2014/0001276 A1
(43) Pub. Date: Jan. 2, 2014

(54) SPRAY BOOM FOR SELECTIVELY SPRAYING A HERBICIDAL COMPOSITION ONTO DICOTS

(71) Applicants: Rasmus Nyholm Joergensen, Horsens (DK); Norbert Krueger, Odense C (DK); Henrik Skov Midtiby, Odense C (DK); Morten S. Laursen, Aarhus C (DK)

(72) Inventors: Rasmus Nyholm Joergensen, Horsens (DK); Norbert Krueger, Odense C (DK); Henrik Skov Midtiby, Odense C (DK); Morten S. Laursen, Aarhus C (DK)

(73) Assignee: SYDDANSK UNIVERSITET, Odense M (DK)

(21) Appl. No.: 14/005,331

(22) PCT Filed: Mar. 14, 2012
(86) PCT No.: PCT/DK12/50074

§ 371 Date: Sep. 16, 2013

(30) Foreign Application Priority Data
Mar. 16, 2011 (DK) PA 2011 00181

(51) Int. Cl. A01M 7/00

(52) U.S. Cl. CPC A01M 7/0089
USPC 239/1; 239/69

(57) ABSTRACT

There is provided a method and spray boom for discriminating cereal crop (monocot) and weeds (dicots). The spray boom includes means for digitally recording an image of a selected area to be treated by a nozzle on the spray boom, whereby a plant material is identified based on a segmentation procedure; and means for detecting the edges and estimating the angles of the edges of the leaves so as to discriminate between dicots and monocots; and means for activating one or more of the spray nozzles in response to detected dicots so as to selectively apply the herbicidal composition onto the sensed area containing the dicots.

### FIELD OF THE INVENTION

The present invention relates to a method and spray boom for discriminating cereal crop (monocot) and weeds (dicots) and relates particularly, but not exclusively, to an agricultural spray boom that incorporates such a spray boom.

### BACKGROUND OF THE INVENTION

The most commonly used technique for broad acre spraying of pesticides is the use of a wide sprayer boom, which may be self-propelled or towed behind another vehicle. A typical sprayer boom has a plurality of spray nozzles mounted at spaced locations along a boom, a large tank for containing the spray liquid and a pump system for pumping the liquid to the nozzles.

One of the disadvantages of conventional sprayers is that herbicides are sprayed indiscriminately on the crop, bare ground and weeds. This is of concern in the case of food crops, with consumer groups becoming increasingly vocal about chemical residue in crops and livestock. There is also an economic disincentive since a much greater volume of chemicals must be applied per hectare than is actually required to effectively control the weeds.

Today's conventional agricultural practise is to spray an average herbicide dosage one to several times within a cereal field with no regard to the spatial distribution of crop plants and weeds. Attempts have been made registering or mapping the weed distributions and then apply variable herbicide rates. This procedure has mainly been done manually and recently in an automated and vision based manner. However the current algorithms discriminating the cereal crop (monocot) and weeds (dicots) fails in most cases due to leaf occlusions. Furthermore the present algorithms are computer intensive.

Hence low cost real time discrimination is currently not possible. Furthermore, leaf occlusion between the single plants makes it very difficult to separate the single crop and weed plants, which prohibits any classic discrimination algorithms to be applied with success.

Current real time systems for crop and weed discrimination is mainly capable of operation within crops seeded in rows. After identifying the extent of the crop rows the crop canopy free intra rows area is used to identify areas of living plant material which is then identified as weed. This approach is commercially operational today in real time. The main problem with the latter approach is the dependency of a crop free intra row strip. Within the majority of cereal crops, and especially within autumn sown winter cereals the intra row strip vanish quickly during the tillering stages where multiple planophile cereal leaves enter the intrarow strip between the crop rows 125 mm apart. Hence the occurrence of overlapping or occluded crop and weed leaves makes it highly complex to discriminate cereals and dicotyledon weeds with the methods known today.

Lee et al (Precision Agriculture, 1, 95, 113, 1999) disclose a spray boom for selectively spraying a herbicidal composition onto dicots in a living vegetation. The spray boom comprises a plurality of spray nozzles evenly distributed along the spray boom (“valve/nozzle array”) and means for activating one or more of the spray nozzles in response to detected dicots so as to selectively apply the herbicidal composition onto the sensed area containing the dicots. Moreover it comprises means for digitally recording an image of the selected area to be treated by a nozzle on the spray boom, whereby the plant material is identified based on a segmentation procedure that transform the raw image data of the image into a measure which describes the likeliness that a given pixel or point of the image is a living vegetation, such as leaves. Meanwhile, Lee at al do not disclose any means for detecting dicots by estimating the curvature of the leaves by sampling locally distributed points placed on the edges of the leaves. Especially, Lee at al do not disclose any means for estimating the curvature measuring the orientation of the edge at points in a global coordinate frame. Importantly Lee at al do not provide any means for estimating the orientation of the leaves and how to extract and interpret relevant features.

It is an object of the present invention to develop new technology with high environmental impact for the agricultural market by reducing the amount of herbicide usage significantly.

Particularly it is an object of the present invention to develop a novel vision based decision system for modified conventional sprayer booms, which is able to detect and apply herbicides on weed plants in real time with a capacity comparable to available sprayers.

It is a further object of the present invention to provide a spray boom that is able to quantify the extent and ratio between cereal crop (monocot) and weeds (dicots), as well as occluded cereal crop (monocot) and weeds (dicots).

### SUMMARY OF THE PRESENT INVENTION

The present invention was developed with a view to providing a more efficient method and spray boom for discriminating different types of ground vegetation in agriculture, without the need to change hardware components of the spray boom every time a different type of plant is to be discriminated.

A unique feature of the present invention is automatic estimation of the ratio of weed leaf area relative to the total vegetation leaf area. The computation requirements are relatively low and can to a large extent be paralleled processed (e.g. by a FPGA, a DSP, or potentially a GPU unit) based on standard image processing primitives.

Especially the present invention ensures a proper detection despite occluded leaves. Prior art methods mainly assume that the plants are clearly separated with no overlapping leaves.

So the invention will replace or supplement the algorithms currently used in matrix based images to discriminate and quantify the ratio between cereal and dicotyledon weeds.

The invention utilizes the known difference in appearance between monocots (long narrow leaves) and dicots (shorter and roundish leaves). Despite overlapping leaves the method can be used in a robust and computer efficient manner to estimate the ratio between visible monocot and dicot leaves. The feature that enables this is based on edge detection algorithms used for discriminating the elongated and roundish leaf shapes despite of occluded leaves.

The method and spray boom of the present invention utilize the following basic steps:

1) segmentation of an digitally recorded image in vegetation and soil regions;

2) detection of edges of identified leaves;

3) extraction of statistical features which describe the relative orientation and spatial properties of the detected edges; and

4) Interpretation of the statistical features resulting in a measure of the dicot cover.

According to one aspect of the present invention there is provided a spray boom for selectively spraying a herbicidal composition onto dicots in a living vegetation, the spray boom comprising:

means for digitally acquiring an image of a selected area to be treated by a nozzle on the spray boom, whereby a plant material is identified based on a segmentation procedure that transforms the raw image data of the image into a measure which describes the likeliness that a given pixel is living vegetation, such as leaves;

means for detecting dicots by estimating the curvature of the leaves by sampling locally distributed points placed on the edges of the leaves, said means for estimating the curvature measuring the orientation of the edge at the points in a global coordinate frame;

a plurality of spray nozzles evenly distributed along the spray boom;

means for activating one or more of the spray nozzles in response to detected dicots so as to selectively apply the herbicidal composition onto the sensed area containing the dicots.

According to another aspect there is provided a method for selectively spraying a herbicidal composition onto dicots in a living vegetation, said method comprising the following steps:
segmentation of an image into points of a selected area of a field in living vegetation and non-vegetation regions;
detection of dicots by determining the curvature of the leaves through sampling locally distributed points placed on the edges of the leaves and measuring the orientation of the edge at the points in a global coordinate frame and
spraying the herbicidal composition to the selected area , wherein dicots have been detected.

### BRIEF DESCRIPTION OF THE DRAWINGS

FIG. 1 is an illustration of the spray boom.

FIG. 2 shows estimations of Dicot ratio, compared to a known reference (Samples sorted by reference ratio).

FIG. 3 shows relation between reference and estimated dicot coverage optimized for lowest mean error.

FIG. 4 shows distribution of residual errors of the estimated dicot coverage lowest mean error.

FIG. 5 shows the relation between points on the edge.

FIG. 6 shows the relation between pain s on he edge for a monocot compared to a dicot.

### DETAILED DESCRIPTION OF THE INVENTION

In the following these steps are described in more detailed.

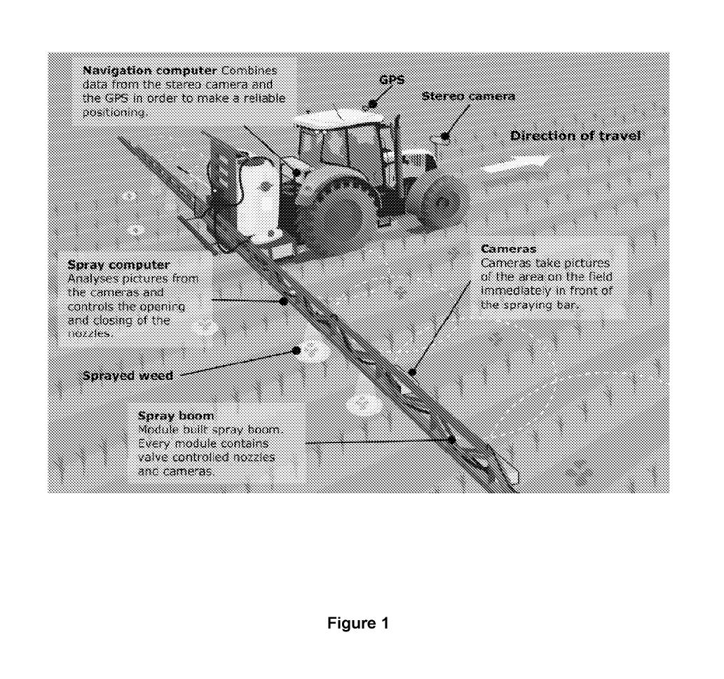

As shown in FIG. 1 the spray boom has a set of digital cameras in a vision system that takes images of the field surface immediately in front of the spraying boom. The images are analysed for the occurrence of crop and weed. When one or more weeds are found in the image, the information about their location is saved in a spray map. The image is normally divided into rectangular units (cells) of 200 mm in the driving direction and 250 mm orthogonally to the driving direction. Since the cameras are fixed in relation to the spraying boom, the cells are placed so that the nozzles—with a certain time lapse—pass over the middle of each cell. Under good light conditions the cell sprayer can operate with a forward speed of approximately 3-4 m/s. Commercially available nozzles modified with high speed valves are used to control weeds. The overall conclusions were that it was possible to control weeds with an efficacy comparable to what is achieved with today's broadcast spraying.

Although the invention will be described primarily with reference to the selective spot spraying of weeds, it will be apparent that the method and spray boom for discriminating different types of ground vegetation may also be used to identify weeds for mechanical destruction, mapping of weed infestation coupled with a global positioning system (GPS) or differential global positioning system (dGPS), differentiated spraying of liquid fertiliser on crop plants, measurement and logging of crop vigour, and other weed and crop management practices.

In order to facilitate a more detailed understanding of the nature of the invention a preferred embodiment of a spray boom and method for discriminating different types of ground vegetation will now be described in detail.

The method of the present invention involves the following steps:

1) segmentation of the image in living vegetation and non-vegetation regions;

2) detection of edges with orientation of the gradient at the individual pixels;

3) Extraction of statistical features which describe the relative orientation and spatial properties of the detected edges; and

4) Interpretation of the statistical features resulting in a measure of the monocot/dicot ratio.

Below is each of the steps described more detailed.

1. Segmentation

The segmentation serves to transform the raw image data into a measure which describes the likeliness that a given pixel is living vegetation. Within the domain there is primarily two ways which is typically used to accomplish this, one is normally referred to as Excessive green, the other as the normalized difference vegetation index.

Excessive green is defined as 2G-R-B where G defines the green part of the plant reflection, R the red part and B the blue part. It relies on the fact that the plant has a high absorption of blue and red light, but a low absorption of green. Normalized difference vegetation index (NDVI) is normally defined as (NIR-31 Red)/(NIR+Red).

The method used is capable of mapping the raw images into a description where pixels with living plant material are separated from the rest.

The image is segmented so plant material and soil is clearly separated. Excessive green relies on the green peak seen at 550 nm, where the normalised vegetation index relies on the high near infrared reflection (the use of the red channel is primarily a way of reducing false positives).

2. Edge Detection

After the image segmentation, the edges in the image are located. This can be performed using a filter bank consisting of Gabor kernels, with constant size and scale but different orientations, using a structure tensor or various other methods. For the Gabor method the edge image is constructed using the maximum response from the filter bank. This edge image is thresholded and thinned until a single pixel wide edge remains. For each pixel still in the edge image, the orientation of the local edge is determined from the gabor responses. By looking at which Gabor orientation yielded the maximum value for that edge point, the orientation of the Gabor kernel yielding the maximum response then directly corresponds to the orientation of the edge when combined with the sign of the imaginary part of the response at the pixel.

For the edge detection the contour of the segmented objects is extracted. The contour description should contain both the spatial coordinates as well as the orientation of the edge, and on which side of the edge the segmented object is positioned.

The edge is extracted in order to be able to define some features based on the shape of the plant. In order to extract this information a filter bank consisting of Gabor filters is applied. Each of these filters is designed in such a way as to have maximum magnitude response, when the kernel is placed centre on an edge, with the orientation of the kernel matching that of the edge.

In order to calculate the kernel of the Gabor filter, division into three parts is required; the propagating wave, the damping and the rotation of the kernel. The propagating wave simply relies on the definition of complex numbers which says that we can describe a complex wave as an exponential as:

e^{jΘ}=cos(Θ)+j·sin(Θ)

Applying this to the propagating wave of the Gabor it can described as:

e^{2π·f·x′j}=cos(2π·f·x′)+j·sin(2π·f·x′)

Where f denotes the frequency, and denotes the position in the kernel given along the wave's direction of propagation.

The dampning can be described as an exponential decay towards the edge of the kernel as

e^{-(α}^{²}^{·x′}^{²}^{′β}^{²}^{·y′}^{²}⁾

Where α describes the sharpness of the Gaussian bell along the wave and β describes the sharpness of the Gaussian bell across the wave. χ′ still denotes the position in the kernel along the wave propagation and y′ denotes the position across the wave.

This allows the Gabor kernel to be expressed as:

G(x,y)=e^{-(α}^{²}^{·x′}^{²}^{′β}^{²}^{·y′}^{²}⁾·e^{2π·f·x′·j}

x′ and y′ can be defined by a rotation given by the angle Θ as:

x′=x·cos(Θ)+y·sin(Θ)

y′=y·cos(Θ)−x·sin(Θ)

Where x, y defines the position in the kernel along the horizontal and vertical direction in the image.

For the Gabor filters there is a set of parameters which must be selected

1. Frequency

2. Sharpness/damping of Gaussian along and across the direction of propagation

3. Amount of different angles (how large should the filter bank be)

4. Size of filter mask

Each of these parameters is a compromise.

For selecting the frequency, the lower bound is defined by how small blobs should be detected; if the frequency is too low, it will not be able to detect the smaller weed blobs. If the frequency is too high we will have an increased sensitivity to noise. As the images the Gabor filter is working on is near binary, the edge can considered a Heavyside step function, therefore energy will be present at all frequencies. Since the blobs of the weed is sometimes fairly small (down to 4 pixels across a leaf) in the test dataset, a high frequency of f=0.4 has been chosen (normalized frequency (cycles per pixel)).

Sharpness of the filter along the wave propagation should ensure that the sampling of the edge is localized and as we do not wish to be extra sensitive to texture only a single period should be contained within the Gaussian bell, the sharpness has been set to α=0.8, which results in that more than 99% of the contribution comes from the pixels which lies in a distance of less than or equal to 2 pixels away from the pixel being measured. Across the direction of propagation the sharpness defines how many of the neighbouring pixels aid in the definition of the orientation of the edge. If the bell is to narrow then the angle will be noisy, if it is too large it will be insensitive to sharp curves, we have chosen a sharpness of β=0.8.

The amount of different angles is another compromise primarily between computational efficiency and the angular resolution, as computational efficiency is not a parameter for this project no further time has been spend on optimizing this parameter, and tests has been performed using 8 Gabor filters which equals a resolution of 22.5°

A core feature of the present invention is the detection of dicots by estimating the curvature of the leaves by sampling locally distributed points placed on the edges of the leaves, and measuring the orientation of the edge at the points in a global coordinate frame;

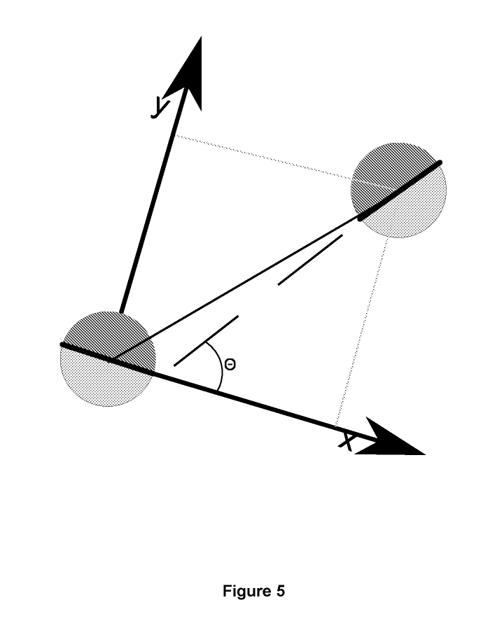

By measuring the orientation of the edge at a local point in a global coordinate frame, a description of each edge point can be obtained, if each point is combined along the edge with the other points on the edge as shown in FIG. 5. The relation of each combination of two edge points can be described. Using this description on all points which is a distance less than a maximum distance (e.g. 125 pixels), a set of fingerprints can be created for an image based on a histogram of the description. From these fingerprints the density of a set of strategically chosen areas is measured. From these measurements an evaluation can be performed to estimate the amount of leaf coverage. For this work the estimation was performed by performing a non-linear regression on a known reference using a genetic algorithm.

3. Feature Extraction

To describe the shapes in the image, the relative location and orientation of pairs of edge pixels are examined. The relative measures are used in order to obtain spatial and rotational independence. The relative location of two edge pixels is described using the parameters: x, y and \theta. By looking at all pairs of edge pixels with an internal distance lower than a given threshold (e.g. 125 pixels), the distribution of the three parameters x, y and Θ an be investigated using 2D histograms. These histograms are the “fingerprints” of the examined structure represented in a rotation and position invariant way.

4. Interpretation

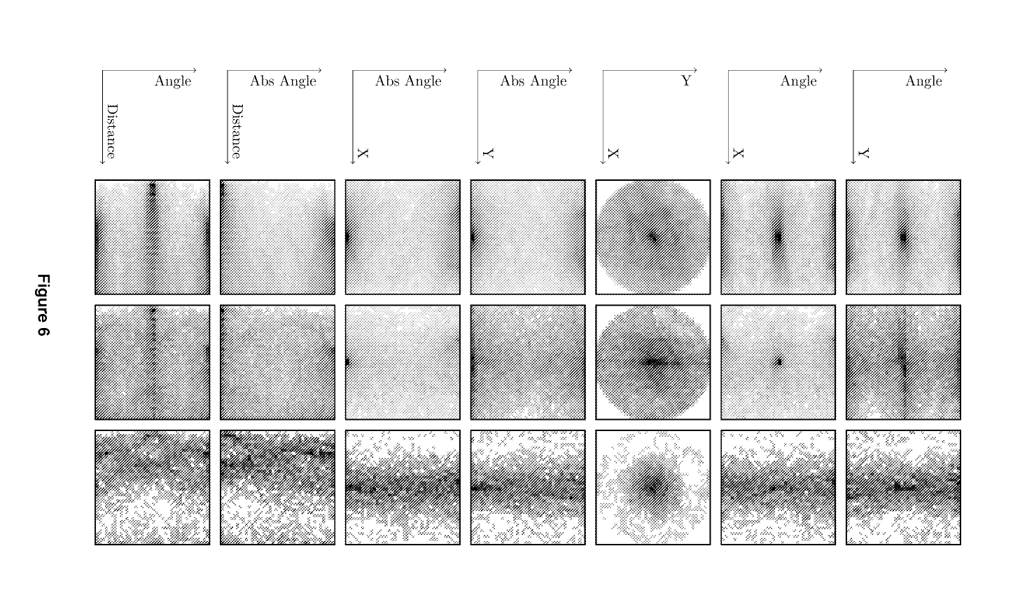

The statistical features can be visualized as a kind of “fingerprint” image. Three such fingerprints are shown in FIG. 6, one for pure monocots, pure dicots and finally a mixture of the two plant types

Mixture (Nightshade and Maize)

Based on the illustrated fingerprints and variation of these it is possible to quantify the amount and ratio between monocotyledons (cereal crops and grass weed) and dicotyledons (weeds) in a computational efficient manner. For interpreting the fingerprints a set of 9 features has been created, each of these features is a subset of the points selected to approximate a given property of the plant. A feature is defined as a measure of the points density within a given area of the fingerprint. Even though some of the properties is not always approximated closely, in some cases the features has been kept as they have shown a strong correlation to the weed coverage. The 9 features are

Straightness—describes the straightness of the plant

Mean distance

Width consistency

Colinearity

Colinearity 2. attempt

Energy at 90 degrees

Energy at 90 degrees measured at a distance of 50 pixels

Energy at 90 degrees measured at a distance of 90 pixels

Rotational Variance

The initial results based simulations using 1000 artificial images with varying densities of maize (monocot) and weeds (dicots) is illustrated below. The results has been obtained using the data estimation tool Eureqa, made by Cornell University, which uses a Genetic Algorithm to find the equation which best describes a point cloud. When optimizing for the lowest mean error this results in a mean error of 0.54% and an maximum error of 41%. When optimizing for lowest maximum error, the mean error is 7.8% with a maximum error of 24.8%.

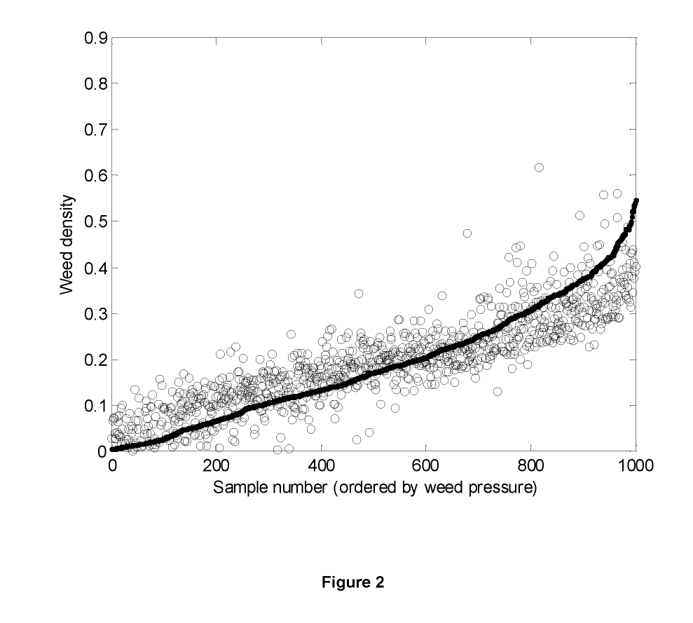

Referring to FIG. 2 there is shown 1000 test images with changing weed densities were analyzed with Modivoci. The figure show the relation between the actual weed density and the estimated weed density.

All samples were ordered according to the actual weed density (plotted as the thick black line). For all samples were the estimated weed density shown as black circles. The figure proves that the estimated weed pressure provided by Modicovi is strongly correlated to the actual weed pressure.

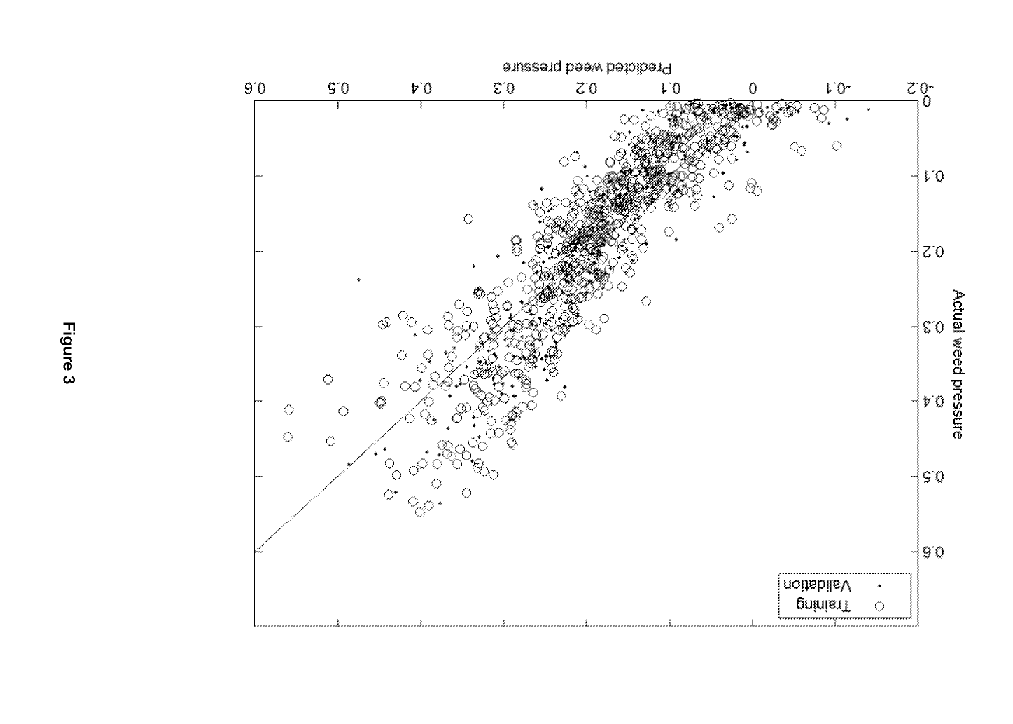

Referring to FIG. 3 the correlation between the actual weed pressure and the predicted weed pressure is shown. The samples used for training the estimator are marked with circles and the test samples are marked with solid dots.

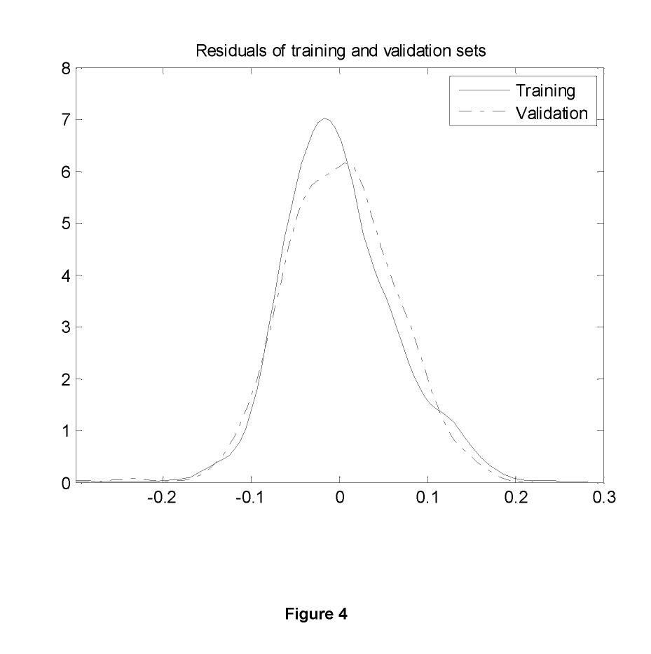

Referring to FIG. 4 analysis of prediction errors is shown. It is seen that the error distribution in the training set is similar to the error distribution in the validation set. This indicates that system has learned something general about the dataset and not just memorized the training set.

Referring to FIG. 5 there the relative position and orientation between two neighbor edge segments is shown. The two circles mark the location of the detected edges while the gray shading of the circles indicates the orientation of the detected edges. A coordinate system is centered on one of the edge segments and oriented such that the y axis points towards the plant material (dark side of the circles). The location of the other edge segment is then described in this coordinate system and the relative orientation is the angle marked as theta.

Referring to FIG. 6 fingerprints of different plant types are shown. In three test images edges have been detected and compared with neighbor edges. Each of the test images corresponds to one column in the figure; the first image/column contained only maize plants; the second image a combination of maize and weeds and the third contained only weeds. The first row in the figure shows the relation between y coordinates of neighbor edges and their relative orientation (marked in the sketch coordinate system to the left), areas with a high number of observations are marked with dark colors and areas where few observations is made is marked with light colors. It should be noticed how the maize and weeds each have a certain pattern or fingerprint. The remaining rows contain similar fingerprints based on different coordinate representations.

1. A spray boom for selectively spraying a herbicidal composition onto dicots in a living vegetation, the spray boom comprising:
means for digitally recording an image of a selected area to be treated by a nozzle on the spray boom, whereby a plant material is identified based on a segmentation procedure that transforms the raw image data of the image into a measure which describes the likeliness that a given pixel or point of the image is living vegetation, such as leaves;
means for detecting dicots by estimating the curvature of the leaves by sampling locally distributed points placed on the edges of the leaves, said means for estimating the curvature involves measuring the orientation of the edge at the points in a global coordinate frame, thereby generating data on spatial coordinates as well as the orientation of the edge, and on which side of the edge the segmented object is positioned;
a plurality of spray nozzles evenly distributed along the spray boom;
means for activating one or more of the spray nozzles in response to detected dicots so as to selectively apply the herbicidal composition onto the sensed area containing the dicots.

2. A spray boom according to claim 1, wherein the selected area to be treated is less 250 mm×200 mm.

3. A spray boom according to claim 1, wherein the measure which describes the likeliness that a given pixel is living vegetation is based on thresholding Excessive Green (2xGreen-Red-Blue) or NDVI ((NIR−Red)/(NIR+Red).

4. A method for selectively spraying a herbicidal composition onto dicots in a living vegetation, said method comprising the following steps:
segmentation of an image into points of a selected area of a field in living vegetation and non-vegetation regions;
detection of dicots by determining the curvature of the leaves through sampling locally distributed points placed on the edges of the leaves and measuring the orientation of the edge at the points in a global coordinate frame thereby generating data on spatial coordinates as well as the orientation of the edge, and on which side of the edge the segmented object is positioned; and
spraying the herbicidal composition to the selected area , wherein dicots have been detected.
